(19) United States
(12) Patent Application Publication
(10) Pub. No.: US 2016/0222972 A1
(43) Pub. Date: Aug. 4, 2016

(54) APPARATUS AND METHOD FOR PUMP CONTROL AND OPTIMIZATION

(71) Applicant: Nuhn Industries Ltd., Sebringville (CA)

(72) Inventor: Ian Nuhn, Sebringville (CA)

(73) Assignee: Nuhn Industries Ltd., Sebringville (CA)

(21) Appl. No.: 15/015,092

(22) Filed: Feb. 3, 2016

Related U.S. Application Data
(60) Provisional application No. 62/111,657, filed on Feb. 3, 2015.

(51) Int. Cl. F04D 27/00; G05B 13/02

(52) U.S. Cl. CPC F04D 27/00; G05B 13/0285

(57) ABSTRACT

A pump energy optimization method comprises determining the fluid output of a plurality of pumps and adjusting an energy modulating structure of each pump until both of the following conditions are met: i) a target fluid output is achieved; and, ii) total energy consumption of the plurality of pumps is minimized. An apparatus comprising input and output structure, an operator interface and a microprocessor is also provided for implementing the method.

### CROSS-REFERENCE TO RELATED APPLICATIONS

This application claims the benefit of U.S. patent application 62/111,657, filed Feb. 3, 2015, which is incorporated herein by reference.

### FIELD OF THE INVENTION

The present invention relates to the operation and control of a plurality of pumps connected in a fluid circuit. In particular, the invention relates to an apparatus and method for control of a plurality of connected agricultural pumps, especially manure pumps, in order to optimize total energy consumption of the plurality of pumps.

### BACKGROUND OF THE INVENTION

in agricultural applications, it is common to connect a plurality of pumps in a series or parallel configuration in order to achieve a desired fluid output, such as a desired fluid flow at a desired pressure in a desired location. In one such agricultural application, a plurality of pumps are connected in series in order to deliver liquid manure from a reservoir to a site where the manure is being applied to a field. The liquid manure may be applied to the field using a “dragline” applicator, or any other suitable application technology.

When a dragline applicator is used, a farm vehicle (e.g. an agricultural tractor) drags a flexible conduit about the field. As the vehicle moves up and down hills and executes turns, the flexible conduit adopts a variety of orientations, which leads to an increase or decrease in fluid pressure and consequently a variation in fluid output. Fluid pressure can also be affected as a result of varying liquid manure consistency (i.e. variable solid content) as the manure is being pumped from a lagoon or other receptacle wherein the liquid manure is non-homogeneous. A control apparatus can be used to manually modulate pump output in order to achieve a preset flow rate. Modulation of pump output may be achieved, for example, by an operator who opens or closes a variable valve (e.g. gate valve) that throttles flow rate from a particular pump. However, this approach requires operator intervention and trial and error in order to achieve the desired flow rate. In addition, the individual pumps operate at a fixed throttle setting, meaning that energy consumption remains fixed regardless of flow rate. In practice, in order to achieve the full range of potential output available from the pump, the fixed throttle setting is usually at the maximum position, which results in significant energy being wasted when a particular pump is throttled.

There remains a need for adjustment of the output of a plurality of pumps in an automated manner to achieve a desired flow condition. In addition, there remains a need for optimization of energy consumption of a plurality of pumps, particularly in situations where the fluid head pressure varies in an unpredictable manner.

### SUMMARY OF THE INVENTION

In one aspect, there is provided an apparatus for control of a plurality of connected pumps comprising: an input connector for connection to a fluid flow sensor configured to measure a fluid output of the plurality of pumps; an input connector for connection to an energy consumption indicator of each pump; an output connector for connection to an energy modulating structure of each pump; an operator interface for providing a target fluid output of the plurality of pumps; and, a microprocessor for implementing a pump energy optimization method comprising determining the fluid output of the plurality of pumps and adjusting the energy modulating structure of each pump until both of the following conditions are met, i) the target fluid output is achieved and ii) total energy consumption of the plurality of pumps is minimized.

The pumps may be connected in parallel or in series. Preferably, the pumps are connected in series. The pumps may be suitable for use in agricultural applications. The pumps may be suitable for use in the pumping of liquid manure.

The pumps may be connected to an internal combustion engine. In this case, the energy modulating structure may comprise a throttle assembly of the internal combustion engine, which may be electromechanically or digitally adjusted. The energy consumption indicator may comprise a fuel flow measurement structure, such as a fuel flow meter, a measurement of fuel pump rotation speed, a measurement of fuel pressure, a measurement of electrical signal to the fuel pump, or a combination thereof.

The pumps may be provided with an electric motor. In this case, the energy modulating structure may comprise a variable speed drive (VFD) or other suitable rotational speed varying structure. The energy consumption indicator may comprise a measurement of voltage, a measurement of frequency, a measurement of current, or a combination thereof.

The fluid flow sensor may comprise a magnetic, ultrasonic, or Coriolis flowmeter. Although other suitable types of flowmeters may be used, in the pumping of liquid manure it is desirable to use a non-contact fluid flow sensor. The fluid flow sensor is desirably positioned at a location downstream of all of the plurality of pumps, in order to be able to measure the total fluid flow output. However, in certain applications, it may be desirable to provide a fluid flow sensor corresponding to each pump and then sum the fluid flow output of each pump in order to obtain the total fluid flow output.

The operator interface may comprise a graphical user interface (GUI) that is accessible via a computer, programmable logic controller (PLC), a touchscreen device, a mobile device, or other suitable hardware. The operator interface may comprise interface structure, such as a button, text box, dial or the like, suitable for entering a desired target fluid flow output from the plurality of pumps. The operator interface may comprise a display of a measurement of total fluid flow output of the plurality of pumps. The operator face may comprise a display of a measurement of total energy consumption of the plurality of pumps. The operator face may comprise a display of a measurement of energy consumption of one or more pumps. The operator interface may comprise a display of a measurement of fluid flow output of one or more pumps. The operator interface may comprise a display of a measurement of fluid pressure of one or more pumps. The operator interface may comprise interface structure to start and/or stop an individual pump or the plurality of pumps. The operator face may comprise a display of rotational speed of one or more pumps. The operator interface may comprise interface structure to adjust rotational speed of one or more pumps. The operator interface may comprise interface structure to open and/or close one or more valves. The operator interface may comprise interface structure to cause optimization of energy consumption of the plurality of pumps.

In another aspect, there is provided a method of optimizing energy consumption of a plurality of connected pumps comprising: measuring a fluid output of the plurality of pumps; determining energy consumption of each pump; providing a target fluid output for the plurality of pumps; and, adjusting an energy modulating structure of each pump until both of the following conditions are met, i) the target fluid output is achieved and ii) total energy consumption of the plurality of pumps is minimized.

The method may further comprise using an artificial intelligence technique to relate energy consumption of each pump to total fluid output of the plurality of pumps and applying the artificial intelligence technique to determine a required adjustment to the energy modulating structure of at least one of the pumps. The artificial intelligence technique may comprise fuzzy logic. The artificial intelligence technique may comprise a neural network. The artificial intelligence technique may comprise a Markov model.

In yet another aspect, there is provided a method of controlling a plurality of connected pumps configured for pumping liquid manure, each pump powered by an internal combustion engine, the method for maintaining a consistent fluid output from the connected pumps under conditions of varying fluid head pressure of the liquid manure and for simultaneously optimizing energy consumption of the internal combustion engines, the method comprising: measuring a fluid output of the plurality of pumps using a non-contact fluid flow sensor; determining a fuel flow of each internal combustion engine; providing a target fluid output for the plurality of pumps; and, using a microprocessor to automatically adjust a throttle assembly of each internal combustion engine until both of the following conditions are met, i) the target fluid output is achieved irrespective of varying fluid head pressure and ii) total fuel flow of the internal combustion engines is minimized. The method may comprise measuring fluid pressure of one or more pumps. The fluid pressure may vary as a function of variable fluid consistency of the liquid manure (i.e. variable fluid solids content).

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is an illustration of an embodiment of an operator interface of the apparatus.

### DESCRIPTION OF PREFERRED EMBODIMENTS

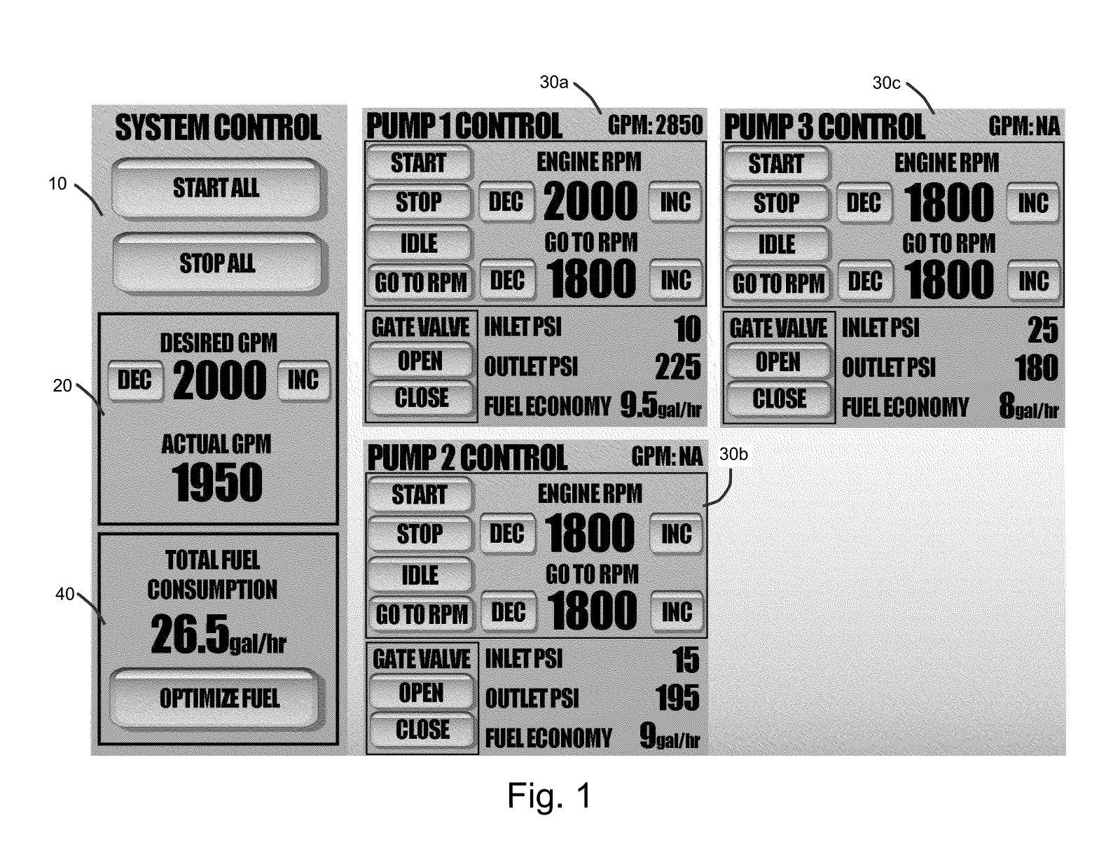

Referring to FIG. 1, an operator interface comprising a graphical user interface (GUI) is shown. An overall system control section 10 of the operator interface comprises interface structure labelled START ALL and STOP ALL for causing the output connector to send signals to the energy modulating structure of each pump to start or stop each pump, respectively. An overall flow section 20 of the operator interface comprises a display of DESIRED GPM and ACTUAL GPM, as well is interface structure labelled DEC and INC to cause a decrease or increase, respectively, to the target total flow output of the plurality of pumps. Pump control sections 30a, 30b, 30c of the operator interface comprise, for each pump, a display of ENGINE RPM, GO TO RPM, INLET PSI, OUTLET PSI, and FUEL ECONOMY. Interface structure is also provided to INC or DEC GO TO RPM (which is a target RPM for the engine when the pump is started), INC or DEC current ENGINE RPM, OPEN or CLOSE a GATE VALVE associated with the pump and START, STOP or IDLE the engine. A display of current pump output in GPM is also provided.

A total energy consumption section 40 of the operator interface includes a display of current TOTAL FUEL CONSUMPTION for all pumps, as well as interface structure labelled OPTIMIZE FUEL to cause the controller to automatically optimize fuel consumption for all pumps while at the same time achieving the DESIRED GPM.

Actuating the interface structure OPTIMIZE FUEL causes a microprocessor of the apparatus to implement a control method whereby total energy consumption of the pumps is determined, current flow output of the plurality of pumps is determined and energy modulating structure of each pump is adjusted to minimize the total energy consumption while achieving the target flow output. In one embodiment, this method utilizes an artificial intelligence technique to determine a relationship between total fluid output and energy consumption of each pump, then applies the relationship to determine a required adjustment to the energy modulating structure of each pump in order to minimize total energy consumption while at the same time achieving the target total flow output. In one embodiment, the artificial intelligence technique employs a neural network, a Markov model, fuzzy logic, or a combination thereof.

The novel features of the present invention will become apparent to those of skill in the art upon examination of the detailed description of the invention. It should be understood, however, that the scope of the claims should not be limited by the preferred embodiments set forth in the examples, but should be given the broadest interpretation consistent with the specification as a whole.

1. An apparatus for control of a plurality of connected pumps comprising:
an input connector for connection to a fluid flow sensor configured to measure a fluid output of the plurality of pumps;
an input connector for connection to an energy consumption indicator of each pump;
an output connector for connection to an energy modulating structure of each pump;
an operator interface for providing a target fluid output of the plurality of pumps; and,
a microprocessor for implementing a pump energy optimization method comprising determining the fluid output of the plurality of pumps and adjusting the energy modulating structure of each pump until both of the following conditions are met,
i) the target fluid output is achieved and
ii) total energy consumption of the plurality of pumps is minimized.

2. The apparatus of claim 1, wherein the energy modulating structure comprises a fuel throttle assembly of an engine connected to each pump.

3. The apparatus of claim 2, wherein the energy consumption indicator comprises a fuel flow measurement structure.

4. A method of optimizing energy consumption of a plurality of connected pumps comprising:
measuring a fluid output of the plurality of pumps;
determining energy consumption of each pump;
providing a target fluid output for the plurality of pumps; and,
adjusting an energy modulating structure of each pump until both of the following conditions are met,
i) the target fluid output is achieved and
ii) total energy consumption of the plurality of pumps is minimized.

5. The method of claim 4, wherein the method further comprises using an artificial intelligence technique to relate energy consumption of each pump to total fluid output of the plurality of pumps and applying the artificial intelligence technique to determine a required adjustment to the energy modulating structure of at least one of the pumps.

6. The method of claim 5, wherein the artificial intelligence technique comprises fuzzy logic.

7. The method of claim 5, wherein the artificial intelligence technique comprises a neural network.

8. The method of claim 5, wherein the artificial intelligence technique comprises a Markov model.

9. A method of controlling a plurality of connected pumps configured for pumping liquid manure, each pump powered by an internal combustion engine, the method for maintaining a consistent fluid output from the connected pumps under conditions of varying fluid head pressure and for simultaneously optimizing energy consumption of the internal combustion engines, the method comprising:
measuring a fluid output of the plurality of pumps using a non-contact fluid flow sensor;
determining a fuel flow of each internal combustion engine;
providing a target fluid output for the plurality of pumps; and,
using a microprocessor to automatically adjust a throttle assembly of each internal combustion engine until both of the following conditions are met,
i) the target fluid output is achieved irrespective of varying fluid head pressure and
ii) total fuel flow of the internal combustion engines is minimized.

10. The method of claim 9, wherein the throttle assembly of each internal combustion engine is electromechanically adjusted.

11. The method of claim 9, wherein the fuel flow of each internal combustion engine is determined using a fuel flow meter.

12. The method of claim 9, wherein the non-contact fluid flow sensor is positioned at a location downstream of all of the plurality of pumps.

13. The method of claim 9, wherein the target fluid output for the plurality of pumps is provided to the microprocessor using an operator interface that displays the fluid output measured by the non-contact fluid flow sensor and displays the fuel flow of the internal combustion engines.

14. The method of claim 9, further comprising measuring fluid pressure of one or more pumps.

15. The method of claim 9, wherein the method further comprises using the microprocessor to implement an artificial intelligence technique to relate fuel flow of each internal combustion engine to total fluid output of the plurality of pumps under conditions of varying fluid head pressure and applying the artificial intelligence technique to determine a required adjustment to the throttle assembly of at least one of the internal combustion engines.

16. The method of claim 15, wherein the artificial intelligence technique comprises fuzzy logic.

17. The method of claim 15, wherein the artificial intelligence technique comprises a neural network.

18. The method of claim 15, wherein the artificial intelligence technique comprises a Markov model.
